(19) United States
(12) Patent Application Publication
(10) Pub. No.: US 2025/0065525 A1
(43) Pub. Date: Feb. 27, 2025

(54) TECHNIQUES FOR PRODUCING SHREDS FROM A FOOD RIBBON

(71) Applicant: HOCHLAND SE, HEIMENKIRCH (DE)

(72) Inventors: CLAUDIO POLIZZI, GESTRATZ (DE); HARRY CHRISTIAN MIESS, NERSINGEN (DE)

(73) Assignee: HOCHLAND SE, HEIMENKIRCH (DE)

(21) Appl. No.: 18/796,315

(22) Filed: Aug. 7, 2024

(30) Foreign Application Priority Data
Aug. 24, 2023 (DE) 10 2023 122 764.5

(51) Int. Cl. B26D 3/24; B26D 1/00; B26D 1/14

(52) U.S. Cl. CPC B26D 3/24; B26D 1/0006; B26D 1/141; B26D 2001/0033; B26D 2210/02

(57) ABSTRACT

A cutting apparatus for producing shreds from a food ribbon. The cutting apparatus includes a first motor unit, a guide track which is driven in a direction of rotation by the first motor unit, and a first knife portion and a second knife portion each of which are arranged on an outer side of the guide track. The first knife portion has a first blade structure with first elevations and first depressions. The second knife portion has a second blade structure with second elevations and second depressions. The second knife portion is arranged offset to the first knife portion. The second knife portion is arranged offset transversely to the direction of rotation so that at least one of the first elevations virtually engages in at least one of the second depressions and at least one of the second elevations virtually engages in at least one of the first depressions.

### CROSS REFERENCE TO PRIOR APPLICATIONS

Priority is claimed to German Patent Application No. DE 10 2023 122 764.5, filed Aug. 24, 2023. The entire disclosure of said application is incorporated by reference herein.

### FIELD

The present invention relates to the technical field of producing shreds from a food ribbon. The present invention describes a cutting apparatus, a cutting system, and a method that makes it possible to cut shreds from a food ribbon.

### BACKGROUND

It is known from the prior art that a continuously fed food ribbon is initially cut lengthwise, for example, and the resulting longitudinal strips are then separated via a roller for cross-cutting. Shreds or so-called “shreds” can thereby be generated in a well-defined shape.

The disadvantage here is, however, that different drives are required for both longitudinal and transverse cutting. The shapes of the shreds are also limited to cube-shaped shreds or rectangular strips, which a customer does not always want to use. The resulting voluminous shreds in particular have a very high weight. Hollow or flat shreds have a much lower weight for a given volume and generally cover a product to be sprinkled more evenly.

EP 3 243 613 B1 describes a method for producing shaped food products by providing a cutting apparatus with at least two successive knives, which each have a wavy shape, in order to generate food product slices with greater amplitude and periodic form, wherein the successive knives are arranged so that they are aligned out of phase with a gap that is provided between the radial position of the successive knives, and operating the cutting apparatus in order to generate food product slices with first portions having a cross-sectional thickness, which is measured as the radial distance between successive knives defined by the gap, which is less than the cross-sectional thickness of second portions of the food product slice. The food product portions are here fed into the interior of the cutting apparatus, and the slices cut out of the food product portions are carried out of the cutting apparatus to the outside. This cutting apparatus can also be referred to as a centrifugal cutting apparatus.

The disadvantage here is, however, that only smaller food product portions can be used since these must be inserted into the interior of the cutting apparatus. It is thus not possible to generate shreds from a continuous food ribbon.

### SUMMARY

An aspect of the present invention is therefore to provide techniques that make it possible to generate shreds from a food ribbon efficiently, in particular continuously, and thus at least partially eliminate the disadvantages of the prior art.

In an embodiment, the present invention provides a cutting apparatus for producing shreds from a food ribbon. The cutting apparatus includes a first motor unit, a guide track which is driven in a direction of rotation by the first motor unit, a first knife portion which is arranged on an outer side of the guide track, and a second knife portion which is also arranged on the outer side of the guide track. The first knife portion comprises a first blade structure with first elevations and first depressions which are transverse to the direction of rotation of the guide track. The second knife portion comprises a second blade structure with second elevations and second depressions which are traverse to the direction of rotation of the guide track. The second knife portion is arranged offset to the first knife portion in the direction of rotation of the guide track. The second knife portion is arranged offset transversely to the direction of rotation of the guide track so that at least one of the first elevations virtually engages in at least one of the second depressions and at least one of the second elevations virtually engages in at least one of the first depressions.

### BRIEF DESCRIPTION OF THE DRAWINGS

The present invention is described in greater detail below on the basis of embodiments and of the drawings in which:

FIG. 1 shows a system for producing shreds from a food ribbon in a perspective view;

FIG. 2 shows the offset arrangement of a first knife portion and a second knife portion;

FIG. 3 shows a section of the system from FIG. 1 in an enlarged representation; and

FIG. 4 shows the system in FIG. 1 in a side view.

### DETAILED DESCRIPTION

The present invention provides a cutting apparatus for producing shreds from a food ribbon. The food ribbon can in particular be a food ribbon made from cheese, tofu, and/or a cheese substitute product. Other food products, such as fruit or vegetables, can in principle also be fed to the cutting apparatus. The cutting apparatus has at least the following features:
A guide track driven via a first motor unit.
   The guide track can in particular be realized by a structure in the form of a roller, a cylinder or a wheel, wherein the corresponding structure (as will be described in more detail below) can have cavities into which the shreds can enter and from which the shreds can again exit. If the structure has the shape of a roller, a cylinder or a wheel, this results in the property that the guide track of an outer side of the structure describes a circular path if the first motor unit drives the guide track. The circulation speed at which the first motor unit drives the guide can be flexibly adjusted.
A first knife portion, wherein the first knife portion is arranged on the outer side of the guide track and has a first blade structure with first elevations and first depressions which are transverse to the direction of rotation of the guide track.
   The first knife portion moves, in particular rotates, i.e., moves with the guide track on the outside; this means that the food ribbon can be fed to the first knife portion from the outside.
   The first blade structure and the second blade structure described below can have multiple or a plurality of these elevations. A possible number of elevations and depressions is, for example, 20 in each case. One configuration of the shape of the elevations and/or depressions influences the shape, in particular the cross-sectional shape, of the shreds generated. Elevations and depressions can, for example, be designed in the following cross-sectional shapes: V-shaped, oval-shaped, wave-shaped, rectangular-shaped and/or diamond-shaped.
A second knife portion, wherein the second knife portion is also arranged on the outer side of the guide track and has a second blade structure with second elevations and second depressions which are transverse to the direction of rotation of the guide track, wherein the second knife portion is arranged offset to the first knife portion in the direction of rotation of the guide track, and wherein the second knife portion is arranged offset transversely to the direction of rotation of the guide track, so that at least one of the first elevations virtually engages in at least one of the second depressions and at least one of the second elevations virtually engages in at least one of the first depressions.
   The term “virtual engagement” is to be understood as follows: due to the offset arrangement in the direction of rotation, the elevations and depressions cannot of course actually engage with one another, but are arranged offset transversely to the direction of rotation so that the at least one elevation of the first knife portion is located at the position of the second depression of the second knife portion if the second knife portion is moved to the previous position of the first knife portion by the movement of the guide track; all elevations and depressions of the first and second knife portions in particular engage with one another as described above. There may be exceptions for the edge regions, for example, because nothing can interlock virtually at the edge regions (where the knife portions come to an end).
   If the blade structure is V-shaped, oval-shaped, wave-shaped, the offset arrangement in the transverse direction can in particular be described so that the elevations and depressions of the first knife portion are arranged, in particular, 90° out of phase with the elevations and depressions of the second knife portion.
   The second knife portion moves, in particular rotates, i.e., moves with the guide track on the outside. This means that the food ribbon can be fed to the second knife portion from the outside.
   The first knife portion thus generates elevations and depressions in the food ribbon, wherein the shreds results from the cut-out depressions. Due to the offset arrangement of the second knife portion, it can now cut the elevations out of the food ribbon as shreds in a subsequent cutting process. Thereafter, in the ideal case, the food ribbon can then again be more or less smooth, wherein the shaving process can be carried forward steadily by continuously feeding the food ribbon to the cutting apparatus.

The cutting apparatus thus provides for the efficient production of shreds from a food ribbon, in particular since the cutting apparatus can be operated with a single motor and because the cutting apparatus enables shreds to be generated from a continuous food ribbon instead of food slices. This is in particular possible since the knife portions are arranged on the outer side of the cutting apparatus.

In an embodiment of the present invention, the knife portions can, for example, be attached to the guide track, in particular radially, at a distance from the guide track, as a result of which a slot is formed between the guide track and the knife portions. The formation of the slot is in particular possible if the body that realizes the guide track has a cavity under the knife portion. The knife portions can, for example, have a slight elevation on one and/or both outer sides and be connected to the guide track at the location of this elevation, for example, by the elevation having a hole-shaped bore through which a fastening element can be passed. The knife portions can have a bridge-shaped configuration due to the elevations in the cross section.

This has the advantage that the shreds generated on the outer side of the cutting apparatus can be inserted into the interior of the body (which realizes the guide track) via the slot. As a result, the shreds do not interfere with the subsequent generation of further shreds and can be guided out of the cutting apparatus in a controlled manner or simply fall out, in order to, for example, reach another ribbon and be removed therefrom.

The guide track can, for example, be provided by a cylindrical body, a roller or a wheel, wherein the cylindrical body has cavities for receiving and/or dispensing the shreds. The cylindrical body, the roller or the wheel have an axle that is operatively connected to the first motor unit and is driven thereby. The guide track moves as a result, and consequently also the knife portions attached to the guide track move.

The cylindrical body, the roller or the wheel have in common that they move the knife portions on a circular track, which is advantageous for the generation of shreds.

The elevations and depressions of the two knife portions can in each case, for example, have the same geometric structure. The elevations and depressions are in each case in particular formed as negatives relative to one another.

This has the particular technical advantage that the shreds can be produced so that as few rejects as possible arise.

A second aspect of the present invention provides a system for producing shreds from a food ribbon. The system is thus in particular a cutting system. The system has the cutting apparatus described above and a feed module, wherein the feed module is configured to feed the food ribbon to the cutting apparatus continuously in a transport direction via a feed belt.

The system thus provides for the efficient production of shreds from a food ribbon, in particular since the cutting apparatus of the system can be operated with a single motor and because the cutting apparatus provides shreds to be generated from a continuous food ribbon instead of from small food portions. This is in particular possible since the knife portions are arranged on the outer side of the cutting apparatus of the system.

In an embodiment of the present invention, the feed module can, for example, be driven by a second motor.

The second motor provides the feed of the food ribbon to the system at a variable transport speed. A change in the transport speed of the food ribbon can be used to influence the shape of the “shreds” as desired.

In an embodiment of the present invention, the feed module can, for example, be configured in order to feed the food ribbon to the outer side of the cutting apparatus.

This has the advantage that (as already described above) a continuous food ribbon can be used to produce the shreds, and smaller pieces need not be placed in the interior of a centrifugal cutting apparatus as in the prior art.

A cutting angle of the food ribbon can, for example, be flexibly adjusted. The cutting angle of the food ribbon is defined by the tangent to the knife portions at the point of contact with the food ribbon and the transport direction of the food ribbon.

The flexible adjustment of the cutting angle has the effect that the shape of the shreds can be changed as desired. The smaller the cutting angle, for example, the longer the shreds will be. The cutting angle can be changed, for example, by changing the angle of attack of the feed module and/or the angle of the knife portions.

In an embodiment of the present invention, the system can, for example, have a counter-knife, wherein the counter-knife is attached downstream of the feed belt in the transport direction, wherein the first knife portion and/or the second knife portion engage in the counter-knife. The counter-knife is here in particular designed as a counter-piece in the form of a negative to the first knife portion and/or the second knife portion so that the elevations or tips of the knife portions engage in valleys of the counter-knife. The counter-knife can be arranged and configured to enable engagement of the first knife portion and/or the second knife portion.

Due to design constraints, it is not possible, or difficult, to process the entire thickness of the food ribbon completely into shreds. This means that at the end of the shaving process, there will remain a thin layer of the food ribbon that has not been shaved. In order to avoid this, an adjustable counter-knife is attached to the tangent point of the cutting system. This counter-knife, which is designed as a negative of the cutting knife, allows the carpet to be avoided and thus the exclusion of small parts. The counter-knife has a profiling that reproduces the negative of the cutting knives. In order to achieve the exact tangent point, the counter-knife can be arranged to be adjustable in one, two or three axles.

A further aspect of the present invention provides a method for producing shreds from a food ribbon, comprising the steps of providing the cutting apparatus described above, and feeding the food ribbon to the cutting apparatus, wherein initially the first knife portion cuts shreds out of the food ribbon, as a result of which third elevations and third depressions are formed on a surface of the food ribbon, and thereafter, the second knife portion cuts shreds out of the food ribbon by its second elevations cutting the third elevations out of the food ribbon.

Exemplary embodiments of the present invention are explained below with reference to the drawings. Numerous features of the present invention are thereby explained in detail. The present disclosure is not, however, limited to the specifically mentioned combinations of features. The features here mentioned can much rather be combined as desired to form embodiments according to the present invention unless expressly excluded below.

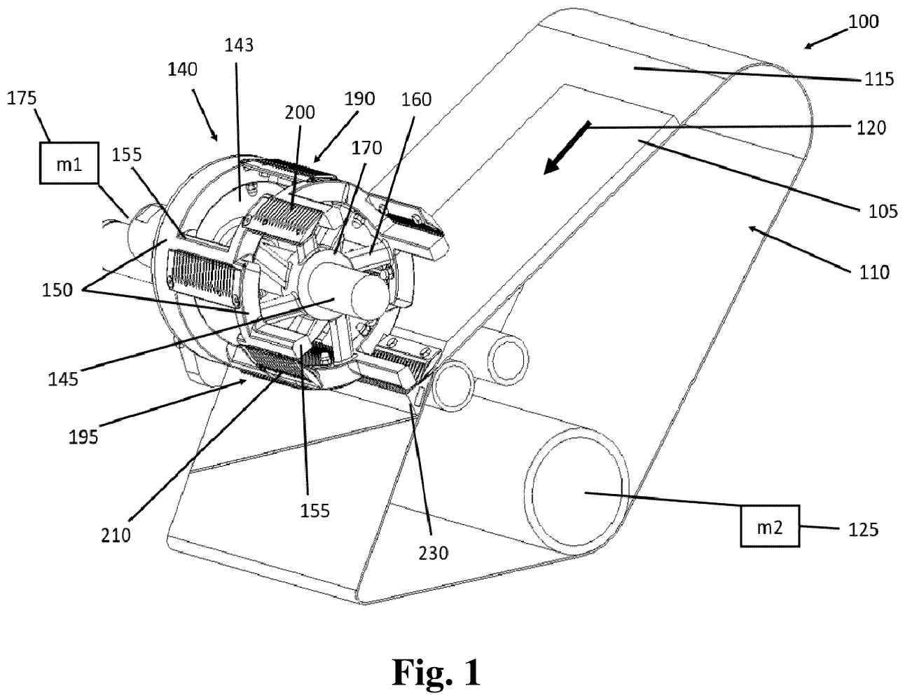

FIG. 1 shows a system 100 for producing shreds from a food ribbon 105, in particular a food ribbon 105 made from cheese or a cheese substitute product, in a perspective view.

The food ribbon 105 is fed from a feed module 110 to a cutting apparatus 140 via a feed belt 115 in a transport direction 120. The feed belt 115 can be driven by a second motor unit 125 which is operatively connected to the feed belt 115, for example, via corresponding drive rollers.

The cutting apparatus 140 can be mounted on an axle 145. The cutting apparatus 140 has a cylindrical body, which has the outer shape of two rings 150, wherein these two rings 150 are spaced apart from one another by support arms 155, in particular by four support arms 155. An alternative way of describing this outer cylindrical body would be that it resembles a cylindrical shell with flat recesses 143. A plurality of spokes 160 lead radially inwards from the rings 150 and are connected in each case to inner rings 170 of a smaller radius. The axle 145 is mounted on these inner rings 170. The cutting apparatus 140 can, for example, be set in a rotary movement by a first motor unit 175 which is operatively connected to the axle 145. The rotary movement of the cutting apparatus 140 can, for example, be provided in a clockwise direction.

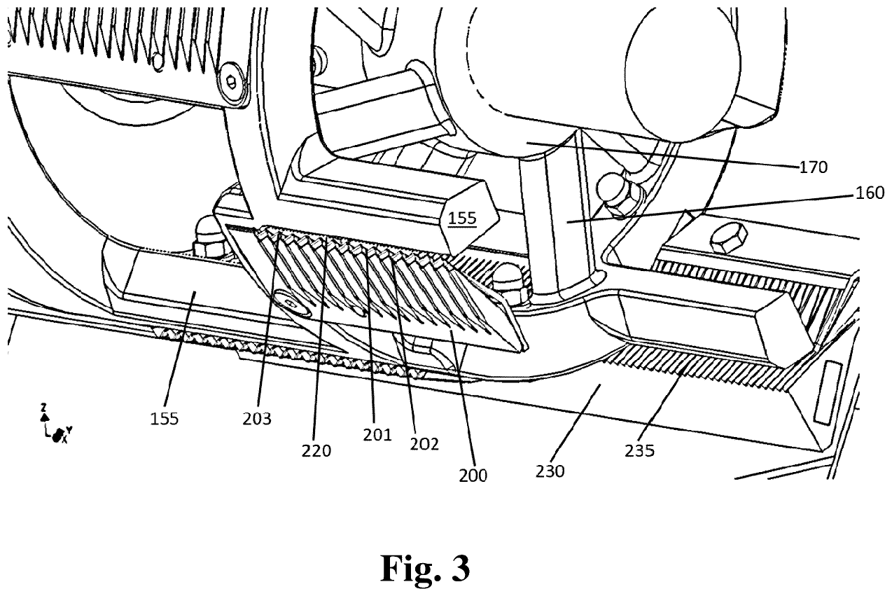

A first row of knife portions 190, comprising a first knife portion 200 and a second knife portion 210, is attached to the two rings 150 at a radially increased distance from the cylindrical body so that the respective knife portions form a kind of bridge between the two rings 150. The knife portions 200, 210 are arranged behind the support arms 155 in the direction of rotation. Due to the radially increased spacing of the knife portions 200, 210, a slot 220 is formed between the knife portions 200, 210 and the support arms 155, which can be seen in an enlarged representation in FIG. 3. A trajectory of the knife portions 200, 210 is referred to as the guide track. The trajectory of the guide track can, for example, be a circle or an ellipse. In the present case, the guide track is realized by the cylindrical body of the cutting apparatus 140.

A second row of knife portions 195 adjoins the first row of knife portions 190 in the direction of the axle 145. For this purpose, further support arms 155 extend from one of the rings 150. In the present case, however, these further support arms 155 are not connected to a further ring, but stand out “freely,” so to speak (it would in principle also be possible, however, to provide a further ring). The second row of knife portions 195 is in principle formed analogously to the first row of knife portions 190. The slot 220 is in particular again formed between the knife portions 200, 210 and the further support arms 155.

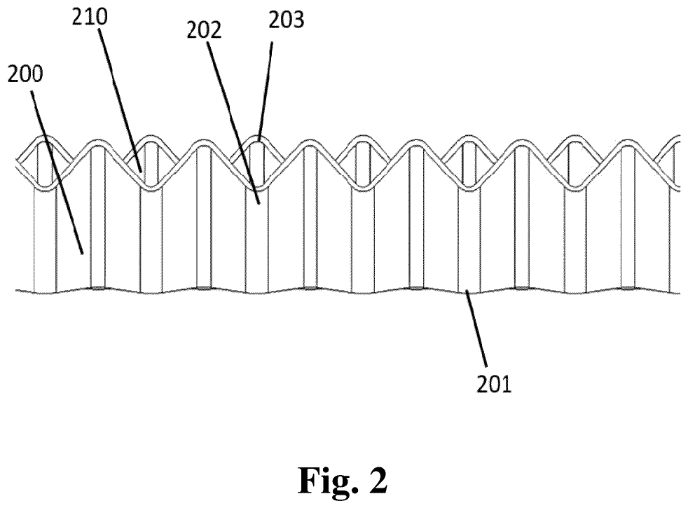

The knife portions 200, 210 in each case have a front cutting edge 201 in the direction of rotation. Transverse to the direction of rotation, the knife portions 200, 210 in each case have alternating elevations 202 and depressions 203. In the direction of rotation, the elevations 202 and the depressions 203 can flatten so that the blade structure flattens out to a flat surface after a few centimeters. The knife portions 200, 210 are offset in the direction of rotation. If, after rotation of the cutting apparatus 140, the knife portions 200, 210 are located at a position where the respective other knife portion 200, 210 was previously located, then a special feature of the present invention provides that the first knife portion 200 and the second knife portion 210 are arranged offset to one another transversely to the direction of rotation so that an elevation 202 of the second knife portion 210 is located at the position of a depression 203 of the first knife portion 200 and a depression 203 of the second knife portion 210 is located at the position of an elevation 202 of the first knife portion 200, as illustrated in FIG. 2. The cutting apparatus can have a plurality of first knife portions 200 and second knife portions 210. It is important, however, that the first knife portion 200 and the second knife portion 210 alternate in the direction of rotation. The knife portions 200, 210 can, for example, be arranged symmetrically (in particular equally spaced in the direction of rotation) on the cutting apparatus 140. The terms elevations and raises have the same meaning within the framework of the present invention.

The above arrangement has the following effect on the cutting process for generating shreds: the food ribbon 105 is brought up to the cutting apparatus; the first knife portion 200 cuts shreds out of the food ribbon 105 with its elevations 202, as a result of which a structure with elevations and depressions is formed on the surface of the food ribbon 105.

These shreds thus enter the slot 220 and thus the cavity of the cylindrical body that forms the cutting apparatus 140. Since the cylindrical body is also open to the outside, the shreds can fall out of the cylindrical body (for example, onto another ribbon) and is transported away therefrom. Meanwhile, the feed belt 115 continues to guide the food ribbon in the direction of the cutting apparatus 140. Due to the rotation of the cutting apparatus 140, the second knife portion 210 next comes into contact with the food ribbon. Due to the offset arrangement of the elevations 202 and the depressions 203 compared to the first knife portion 200, the second knife portion 210 cuts out further shreds from the elevations generated in the food ribbon 105, which in turn, as described above, enter the slot 220 and can subsequently be transported away. Due to the continuous feeding of the food ribbon 105, new shreds are thus steadily generated. The staggered arrangement of the knife portions 200, 210 also limits the length of the shreds.

In terms of design, the cutting apparatus 140 is provided at a distance from the feed belt 115 so that the knife portions 200, 210 do not come into contact with the feed belt 115, since this could possibly damage it, which could blunt the knives and could cause material abrasion in the food, which is to be avoided. The counter-knife 230 is designed as a negative to the first knife portion 200 and the second knife portion 210 so that their elevations engage in grooves 235 of the counter-knife 230, as a result of which the carpet is also cut into strips, which generally have a slightly different shape than the other shreds. This is nevertheless an advantageous way of avoiding rejects. The slot 220 and the counter-knife 230 are shown in an enlarged representation in FIG. 3.

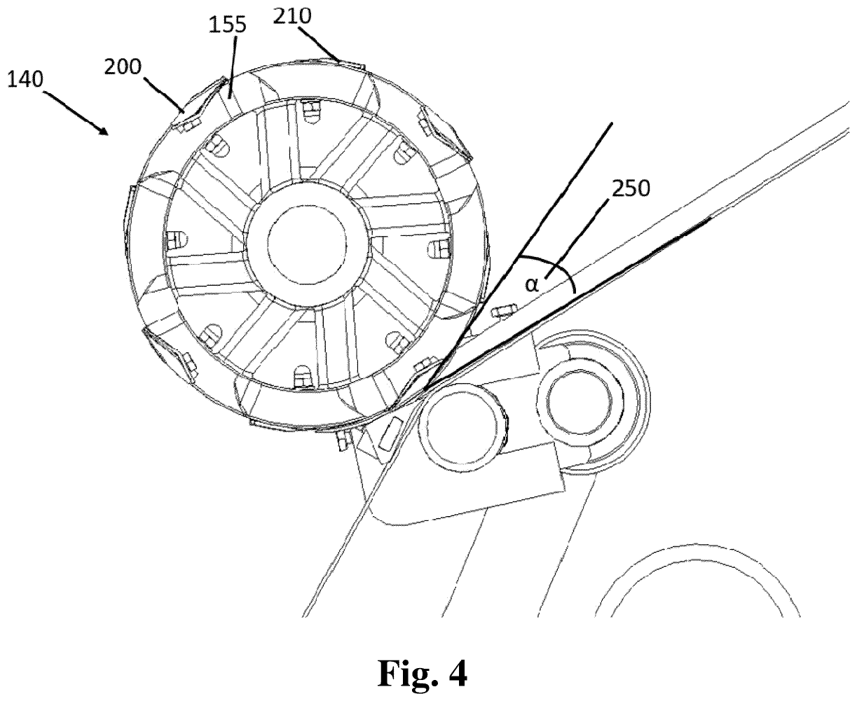

FIG. 4 shows the system in FIG. 1 in a side view. FIG. 4 illustrates the cutting angle α 250. This can be defined as: i) the tangent at the point of contact of the knife portions 200, 210 with the food ribbon 105; and ii) the transport direction of the food ribbon 105. FIG. 4 also illustrates very clearly how the feed belt 115 is guided under the counter-knife 230.

The following features can, for example, further develop the present invention:
i) The geometry of the shaving is determined by the thickness of the food ribbon, the transport speed of the food ribbon, the rotational speed of the cutting apparatus 140 (which may also be referred to as the knife roller 140), and the diameter of the cutting roller and the shape of the knives. The food ribbon can have a thickness of 5-20 mm, for example, 8-12 mm. The transport speed of the food ribbon can be 0.5-20 m/min, for example, 1-10 m/min. The rotational speed of the knife roller 140 can be 100-3000 rpm, for example, 200-1000 rpm. The diameter of the knife roller 140 can be 200-500 mm, for example, 300-450 mm.
ii) The surface quality of the shaving is determined by the variable angle of attack of the knives. The cutting quality and dimensional stability are provided by the variable cutting angle. The cutting angle of the knife portions 200, 210 can be 0-20°, for example, 0-10°.
iii) The elevations 202 and depressions 203 of the knife portions 200, 210 can have a V-shape in cross section. The depressions and elevations can have a depth of 0.5-5 mm and a width of 1-10 mm. The number of depressions and elevations can be selected as required according to the first knife portion 200.
iv) The roller and the feed belt can be variably synchronized with one another in terms of speed.
v) The roller is to be designed in different diameters according to the desired shaving length, for example, 200-500 mm

The features of the various aspects of the present invention or of the various exemplary embodiments described above can be combined with one another, unless this is explicitly excluded or is necessarily technically impossible. The present invention is not limited to embodiments described herein; reference should be had to the appended claims.

### LIST OF REFERENCE CHARACTERS

100 System
105 Food ribbon
110 Feed module
115 Feed belt
120 Transport direction
125 Second motor unit (m2)
140 Cutting apparatus/Knife roller
143 Flat recess
145 Axle
150 Rings
155 Support arm
160 Spoke
170 Inner ring
175 First motor unit (m1)
190 First row of knife portions
195 Second row of knife portions
200 First knife portion
201 Front cutting edge
202 Elevation
203 Depression
210 Second knife portion
220 Slot
230 Counter-knife
235 Groove
250 Cutting angle (a)

What is claimed is:

1. A cutting apparatus for producing shreds from a food ribbon, the cutting apparatus comprising:
a first motor unit;
a guide track which is driven in a direction of rotation by the first motor unit;
a first knife portion which is arranged on an outer side of the guide track, the first knife portion comprising a first blade structure with first elevations and first depressions which are transverse to the direction of rotation of the guide track; and
a second knife portion which is also arranged on the outer side of the guide track, the second knife portion comprising a second blade structure with second elevations and second depressions which are traverse to the direction of rotation of the guide track,
wherein,
the second knife portion is arranged offset to the first knife portion in the direction of rotation of the guide track, and
the second knife portion is arranged offset transversely to the direction of rotation of the guide track so that at least one of the first elevations virtually engages in at least one of the second depressions and at least one of the second elevations virtually engages in at least one of the first depressions.

2. The cutting apparatus as recited in claim 1, wherein the first knife portion and the second knife portion are each attached at a distance from the guide track so as to form a slot between the guide track and the first knife portion and the second knife portion.

3. The cutting apparatus as recited in claim 1, wherein,
the guide track is a cylindrical body or a wheel, and
the cylindrical body or the wheel comprises cavities for at least one of receiving and dispensing the shreds.

4. The cutting apparatus as recited in claim 1, wherein the first elevations and the first depressions of the first knife portion and the second elevations and the second depressions of the second knife portion each have a same geometric structure.

5. The cutting apparatus as recited in claim 4, wherein the same geometric structure of the first knife portion and of the second knife portion is that the first elevations of the first knife portion and the second depressions of the second knife portion are formed as negatives relative to one another, and that the first depressions of the first knife portion and the second elevations of the second knife portion are formed as negatives relative to one another.

6. A system for producing shreds from a food ribbon, the system comprising:
the cutting apparatus as recited in claim 1; and
a feed module which is configured to feed the food ribbon to the cutting apparatus continuously in a transport direction via a feed belt.

7. The system as recited in claim 6, further comprising:
a second motor which is configured to drive the feed module.

8. The system as recited in one of claim 6, wherein the feed module is further configured to feed the food ribbon to an outer side of the cutting apparatus.

9. The system as recited in claim 6, wherein a cutting angle of the food ribbon can be flexibly adjusted.

10. The system as recited in claim 6, further comprising:
a counter-knife which is attached downstream of the feed belt in the transport direction.

11. A method for producing shreds from a food ribbon, the method comprising:
providing the cutting apparatus as recited in claim 1; and
feeding a food ribbon to the cutting apparatus,
wherein,
the first knife portion first cuts out shreds from the food ribbon so as to form third elevations and third depressions on a surface of the food ribbon, and thereafter,
the second knife portion cuts shreds out of the food ribbon via the second elevations cutting the third elevations out of the food ribbon.
